(19) United States
(12) Patent Application Publication
(10) Pub. No.: US 2012/0169461 A1
(43) Pub. Date: Jul. 5, 2012

(54) ELECTRONIC PHYSICAL ACCESS CONTROL WITH REMOTE AUTHENTICATION

(75) Inventor: Richard L. Dubois, JR., Chester, NH (US)

(73) Assignee: SCHNEIDER ELECTRIC BUILDINGS AB, MALMO (SE)

(21) Appl. No.: 12/982,929

(22) Filed: Dec. 31, 2010

(51) Int. Cl. G08B 29/00

(52) U.S. Cl. 340/5.61; 340/5.2

(57) ABSTRACT

The system has an authorizing device, such as a cellular telephone, and a mechanism for receiving information related to a particular facility and the user's access rights based on the location of the authorizing device. The authorizing device is placed in proximity to a secured portal. The user is required to authenticate theirself to the authorizing device via biometric and/or a PIN. The authorizing device then sends a signal to a locking device associated with the secured portal.

### TECHNICAL FIELD

The present invention relates to electronic physical access control (“EPAC”) systems for secured facilities. In particular, it relates to an EPAC system that can grant access based on authentication remote to (beyond) the access control device.

### BACKGROUND OF THE INVENTION

Electronic physical access control (“EPAC”) has been used for many years typically to control ingress to a secured facility, which can be either a facility that is normally secured or one that is secured after a “lock-down” has been initiated. In typical EPAC systems, a user is issued a physical token (usually a machine readable card) that is used by the EPAC system to identify the user. When a user attempts to gain access to a secured facility through some type of secured portal (i.e. door, parking garage gate, fence gate, etc.) controlled by the EPAC system, the user presents the token to an appropriate token reader mounted near the secured portal. A controller that is part of the EPAC system verifies that the user has been granted the right permissions to enter the secured portal by consulting a database. It then electronically unlocks the secured portal if access should be granted.

In other systems, there is no physical token. For example, a biometric signature is used instead. In this case, an appropriate biometric reader at the secured portal is used to measure some unique aspect of the user attempting to gain access, such as a finger print, face print, or retinal pattern.

In still other systems a user enters a personal identification number (“PIN”) on a keypad at the secured portal. In each of these EPAC systems, some type of credential reader hardware is installed outside the secured facility at each secured portal controlled by the system.

### SUMMARY OF THE INVENTION

It has been recognized that expense is incurred with the wiring from each portal to a central control system. It is also recognized that by moving the access control decision beyond the access control device, the access control device can be both cheaper and placed in more remote locations. The system has an authorizing device, such as a cellular telephone, which has a mechanism for receiving information related to a particular facility and the user's access rights based on the location of the authorizing device. The authorizing device is placed in proximity to a secured portal. The user is required to authenticate their selves to the authorizing device via biometric and/or a PIN. The authorizing device then sends a signal to a locking device associated with the secured portal.

In a method for electronic access control to one or more secured portals according to the invention includes an authorizing device having information related to a particular facility and a user's access rights. The authorizing device identifies one of the secured portals to access. Authentication is received by the authorizing device from the user to access the selected portal. The method determines if access is to be granted based on the information related to the facility and the user including the selected portal and the authentication information. A signal is sent to a secured portal if access is determined to be granted.

In an embodiment, the authorizing device receives the information related to the particular facility and the user's access rights wirelessly from a control center. In an embodiment, the control center is remote from the particular facility.

In an embodiment, the authorizing device is a cellular telephone.

In an embodiment, the authorizing device is a dedicated device that contains the information related to the particular facility and information related to the user's access rights is installed with a card.

In an embodiment, the particular facility for which to download related information is determined by the authorizing device providing the authorizing device's location using cellular tower triangulation.

In an embodiment, the particular facility for which to download related information is determined by the authorizing device providing the authorizing device's location using the global positioning satellite system.

In an embodiment of a system for electronic access control to one or more secured portals according to the invention, the system includes an authorizing device capable of storing information related to a particular facility and a user's access rights. The system has a mechanism for identifying a secured portal and a mechanism for authenticating a user. In addition there is a means for transmitting a signal wireless. The system has and is used with at least one portal having a locking device capable for receiving a wireless signal from the authorizing device for granting access through the portal.

In an embodiment, the system includes a control center and a wireless transmission mechanism for transmitting the information related to the particular facility and the user's access rights. In an embodiment, the authorizing device's location and the particular facility to download is determined by the authorizing device's location using cellular tower triangulation.

In an embodiment, the authorizing device's location and the particular facility to download is determined by the authorizing device providing the authorizing device's location using the global positioning satellite system.

In an embodiment, the user's access rights are retained by a card held by the authorizing device. In an embodiment, the authorizing device is a cellular telephone.

In an embodiment, an authorizing device includes a mechanism for storing information related to a particular facility and a user's access rights. The device has a mechanism for identifying a secured portal and a mechanism for authenticating a user. The authorizing device is also capable of transmitting a signal wirelessly.

In an embodiment, the authorizing device includes a wireless receiver for receiving the information related to the particular facility and the user's access rights based on the location of the authorizing device. In an embodiment, the authorizing device's location is determined using cellular tower triangulation. In an embodiment, the authorizing device's location is determined using the global positioning satellite system.

In an embodiment, the user's access rights are retained by a card held by the authorizing device. In an embodiment, the authorizing device is a cellular telephone.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a prior art access control system;

FIG. 2 is a schematic diagram of an embodiment of a cellular-based access control system;

FIG. 3 is a schematic of a method of determining if access should be granted according to the system;

FIG. 4 is a schematic diagram of an alternative embodiment of access control system; and

FIG. 5 is a schematic diagram of another alternative embodiment of access control system.

### DETAILED DESCRIPTION OF THE INVENTION

The present invention is a method and a system for remote access control for one or more secured portals at one or more secured facilities.

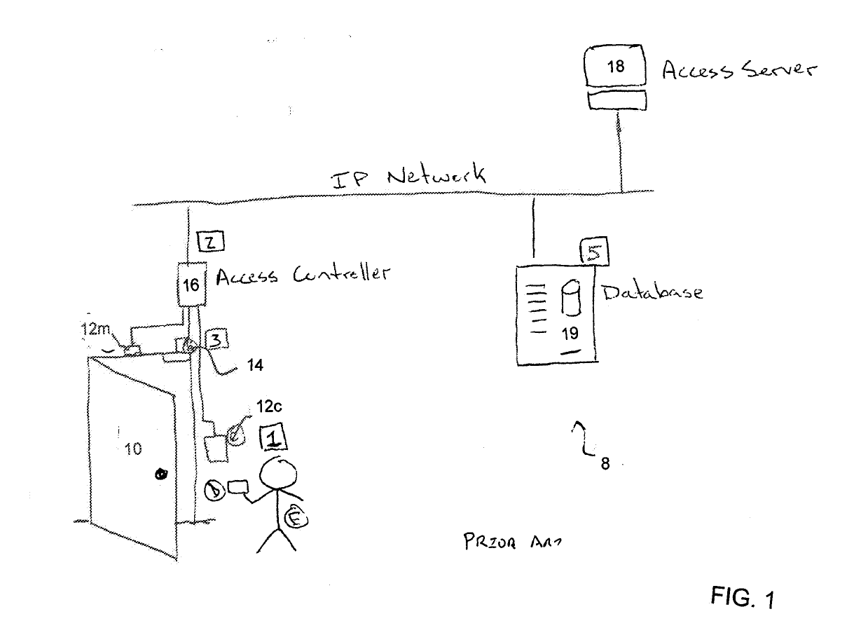

Referring to FIG. 1, a schematic diagram of a prior art access control system 8 is shown. In a typical system, there are a plurality of doors 10 each with inputs 12 and outputs 14. The inputs 12 consist of a card or credential reader 12c, a door switch 12s, and a motion sensor 12m. The output 14 consists of a door striker. These I/O points are tied to a physical access controller 16. In the embodiment show, the card reader 12c is typically an RFID device that requires power.

The physical access controller 16 stores information about user's physical access permissions and the configuration data for the door. The physical access control 16 permissions, user card holder information, and door configuration are stored in a primary access server 18 and are “distributed” to the physical access controller 16. By having copies of all the objects, the physical access controller 16 has enough information to process an access request and unlock the door 10. This typically takes place when a user presents an RFID card to the credential reader 12c. The data is transferred from the reader 12c to the physical access controller 16.

The controller 16 looks up the credential in a local database 19, processes the credential and permissions in a software access control engine, and commands the output to unlock the door 10. It is also responsible for sending the access control event data to the access server 18 where it can be logged for historical purposes in a separate database and viewed live in real time. Changes to permissions, configurations, and credentials originate at the access server and are stored in a database. They are also pushed down or distributed to the physical access controller 16 so that the controller 16 has sufficient information to make a decision at the edge by the door. Since the physical access controller 16 must store many card holders and be able to process the entry requests in a timely manner, the controller 16 is typically an expensive device with a powerful CPU, network connection, large RAM, and large flash for storage of data.

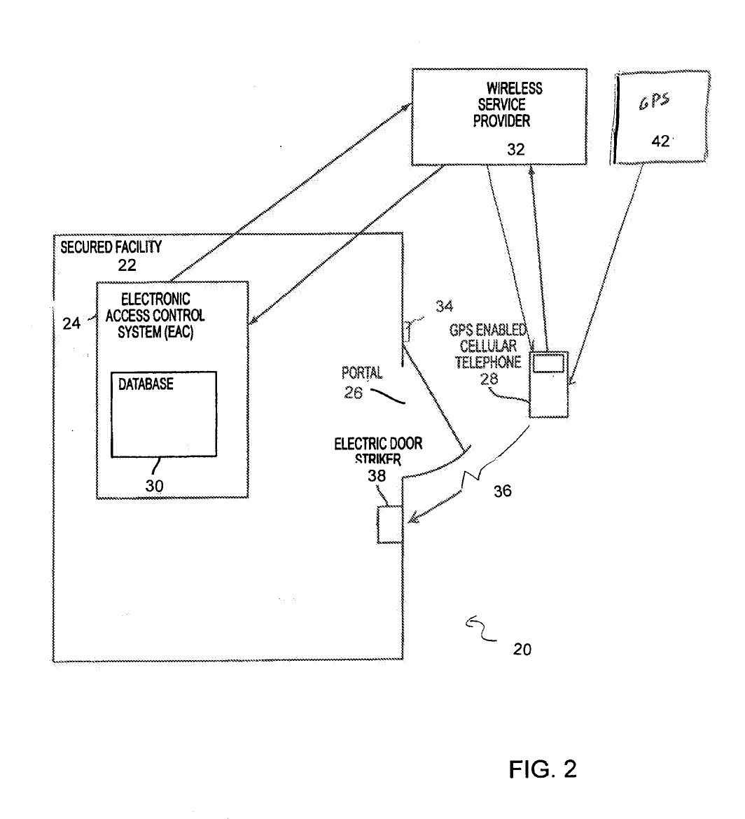

Referring to FIG. 2, a schematic diagram of an embodiment of a cellular-based access control system 20 is shown. The system 20 is used for a secured facility 22. While shown located within the secured facility 22, a control center 24 for the electronic access control (EPAC) system 20 does not need to be located in the facility 22. The EPAC system 20 controls access by users to the secured facility 22 through one or more secured portals 26. As described in more detail below, the control center 24 does not connect directly to the secured portals 26.

When a user with an authorizing device 28, such as a GPS-enabled cellular telephone 28, is in proximity to one of the secured facilities 22 associated with the system 20, the system 20 knows that the telephone 28 is in proximity to the facility 22. The system 20 wirelessly downloads information about the facility 22 to the telephone 28 and the user's access rights from a database 30 using a wireless service provider 32.

When the user approaches a door or portal 26 that the user desires to unlock, the user identifies the door by scanning, using the telephone 28, a bar code, QR (quick response) code, or other identifying mark 34. In addition to identifying the system 20 through the authentication device 28, such as the telephone 28 identifying the door or portal 26, the telephone needs to authenticate the user. In a preferred embodiment, the telephone 28 requires biometric authentication that the user is the stated user. In addition, the telephone 28 requires a code, such as a PIN (personal identification number/code) be entered. With 1) the door identified, 2) the proper person identified (biometric), and 3) the proper information known (the PIN), the telephone 28 sends a signal 36 to an electronic door striker 38 to allow the door or portal 26 to open. The electronic door striker 38 is not required to be connected to the system. Each electronic door striker 38 requires a specific signal.

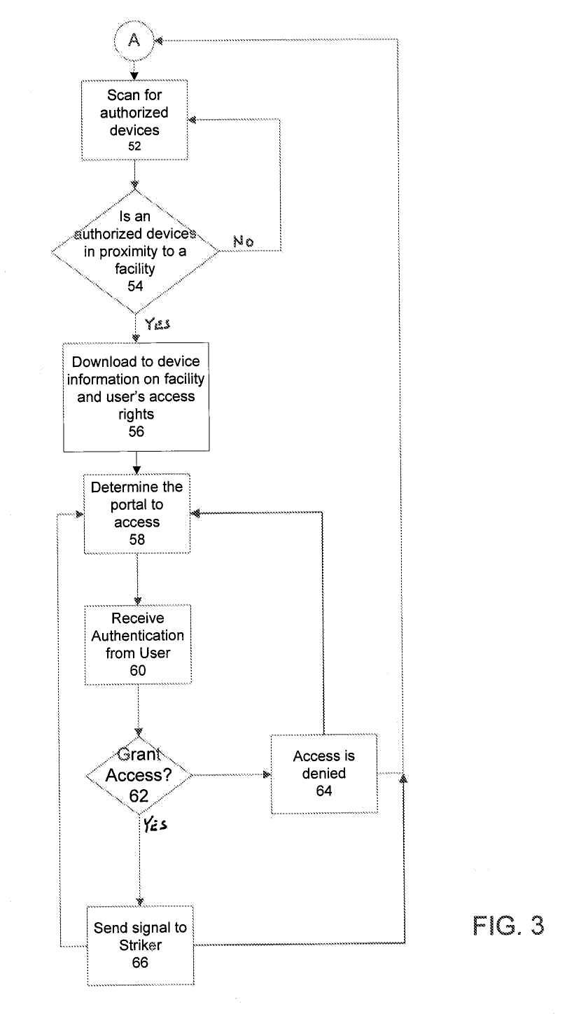

Referring to FIG. 3, a schematic of a method of determining if access should be granted according to the system 20 is shown. The system 20 scans through a wireless system 32, such a cellular wireless service provider 32, for authorized devices 28 such as a cellular telephone 28, as represented by block 52. The system 20 determines if the authorized devices 28 are in proximity to a facility associated to the system 20, as represented by decision diamond 54. The location of the authorized device 28 can be determined either by GPS as represented by block 42 in FIG. 1, or by the tower of the wireless service provider 32 that is communicating with the authorized device 28.

If the system 20 determines that the authorized device 28 is in proximity to a facility associated with the system 20 as represented by the “yes” branch from decision diamond 54, the system 20 downloads to the authorized device 28 information regarding the facility 22 and the user's access right, as represented by block 56.

When the user is in proximity to a door or portal 26, such as seen in FIG. 2, the user places the authorized device 28 in proximity to an indentifying mark 34 and the system 20 determines the portal for which access is requested, as represented by block 58 in FIG. 3. Once the portal has been determined, the system 20 needs authentication from the user, as represented by block 60. As indicated above with respect to FIG. 3, the authentication could be multi-part including biometrics and a PIN.

Still referring to FIG. 3, the system 20 determines if access should be granted as represented by decision diamond 62. The system 20 determines whether access should be granted depending on multiple factors in addition to the authentication, including potential user, time of day, and the particular portal. If access is not granted as represented by the “no” branch from decision diamond 62, the system 20 denies access and can provide indication of such on the authorized device 28 if desired, as represented by block 64. If this occurs, the system returns to a mode where the user needs to input the desired portal. In the alternative, the system 20 may go to a mode where it will accept additional attempts at authentication by the user.

If access is granted as represented by the “yes” branch from the decision diamond 62, the system 20 grants access by having the authorizing device send a signal to the electric door striker 38, such as represented by block 66. The system 20 can provide indication of such on the authorized device 28 if desired.

The system 20 is always scanning for authorized devices 28 as represented by block 52; therefore the system 20 could update the authorized device 28 when necessary. It recognized that the authorized device 28 could have the opportunity to request updated information when desired.

For a third party, the portal 26 would act only like a locked door. There is no card reader or other device to which a third party would recognize the door as an entrance to a secured facility.

The system 20 could have the authorized device 28 retain information on the facility and user's access rights for a limited time period. This would allow the user to proceed to locations where there is no communication between the control center 24 and the authorizing device 28 via the wireless service provider 32.

In that the authorizing device 28 does not use the location as determined by GPS or wireless communication of the wireless service provider 32 to identify the particular secured portal 26, the accuracy of the proximity as described in decision diamond 54 of FIG. 2 does not need to be precise to within a few feet, but rather tens of feet may be specific enough.

Referring back to FIG. 2 related to the location of the authorizing device 28 using GPS, the GPS system 42 sends signals containing precise time information to a GPS-enabled cellular phone 28 enabling it to determine its geographic position. The GPS-enabled cellular telephone 28 then wirelessly transmits its geographic position and a unique identifier, such as its telephone number, to the control center 24 via the wireless service provider 32.

The GPS-enabled cellular telephone 28 can be set to transmit its identifier and geographic position automatically at configurable intervals or only manually. Each such transmission is typically less than 60 bytes in size. In similar fashion, the control center 24 can be set to relay the identifier and geographic position of the GPS-enabled cellular telephone 28 automatically at configurable intervals or manually only when polled by the computer on which the tracking database 30 is maintained.

In that the door striker 38 communicates only to the authorized device 28, the control center 24 does not need to be in the same facility 22. The control center 24 could be in another town, state, or country. While the system 20 describes determining the location of the authorized device 28 in order to download information regarding the facility and user's access rights, the authorizing device 28, such as a cellular telephone, does not need to be able receive a signal from either a GPS or a wireless service provider 32 at the time user wants access to a secured portal 26. The authorizing device 28 has the required information from the control center 24 after the step of downloading as represented by block 56 in FIG. 3.

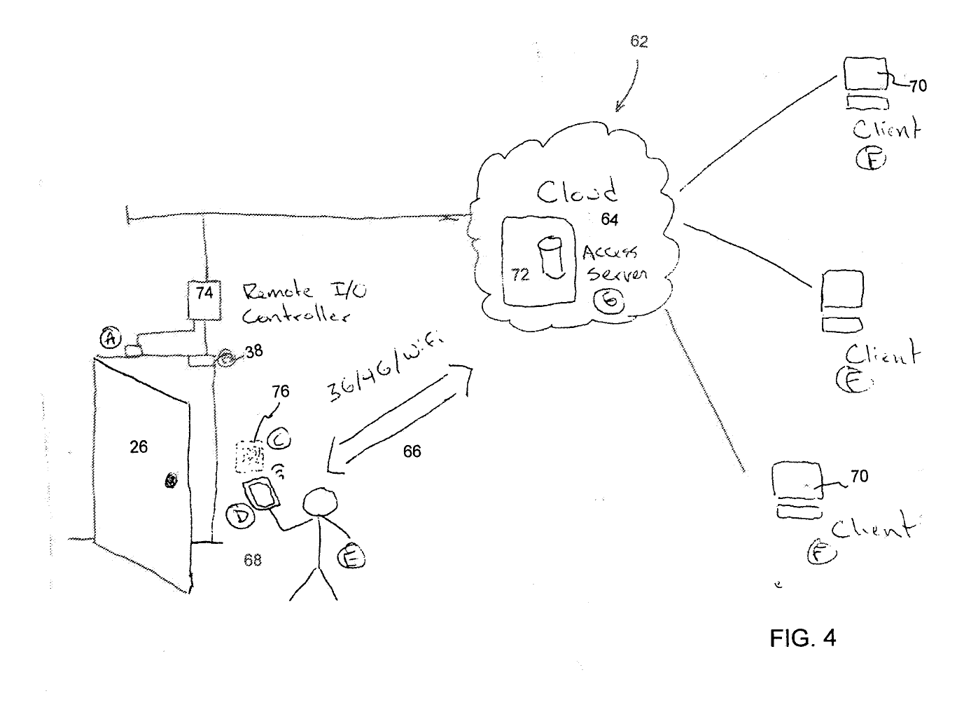

Referring to FIG. 4, a schematic diagram of an alternative embodiment of an access control system 62 is shown. In this embodiment, the conventional access control 8, as seen in FIG. 1, paradigm is turned around. The system 62 utilizing existing technology can push from a cloud 64 credential information, access rights, and door information over a 3G/4G/or WiFi network 66 securely to a mobile computing device 68. The mobile computing device 68, equipped with Near Field Communications technology (NFC in the form of an RFID reader) would then have the ability to process the access request.

One method of using this embodiment is an operator at a client workstation 70 can enroll a person to allow them access to a door or portal 26. The operator configures the permissions, credentials, and mobile device 68 for a particular user. The client stores this information in the access server 72 that is out in the cloud 64. The access server 72 pushes this information to the mobile device 68 of the user over the 3G/4G/or WiFi network 66. The mobile device 68, along with a proprietary access control software application, now has all of the information it needs to make a decision.

The user authenticates themselves to the mobile device 68 via a standard pin entry. In an alternative, a user authenticates themselves to the mobile device 68 via biometric input (finger scan, cardio input, voice recognition etc). With the user authenticated, the user presents the mobile device 68 in the proximity of the door 26. The door 26 has an RFID tag 76; this is in contrast to an RFID reader in a conventional system. The NFC-capable mobile device 68 identifies the door 26 by reading the RFID tag. In an alternative, if the mobile device 68 is not enabled with NFC, the mobile device 68 could scan a bar code at the door using the onboard camera to identify the door as described above with respect to FIG. 2.

In contrast to the conventional method, it is the mobile device 68 that makes the decision about the user's access and sends the request to unlock the door over the 3G/4G/WiFi network 66 to the access server 72 in the cloud 64. In the alternative, the mobile device 68 sends the door information and user/credential information over the 3G/4G/WiFi network 66 to the access server 72 in the cloud 64, and the access server 72 makes the decision.

The access server 72 sends a simple command to a remote I/O controller 74 to unlock the door 26. Some of the advantages of this system 62 includes there is no need to have an expensive RFID reader device at the door 26. In addition, the expensive high-powered access controller that is typically at the door 26 in conventional system can be replaced by a lower cost remote I/O device. Furthermore, the credentials are truly virtual so there is no need buy, print, encode, track, and enroll RFID cards.

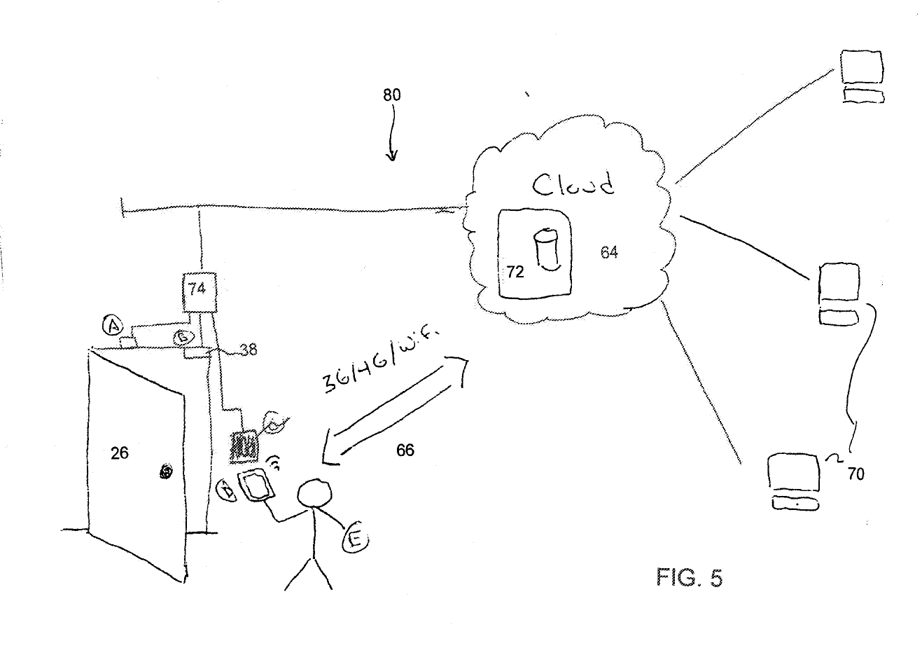

Referring to FIG. 5, a schematic diagram of another alternative embodiment of an access control system 80 is shown. In this embodiment, the system 80 combines features of the previous embodiment, as shown in FIG. 4, and the conventional system 8 of FIG. 1. It shows an example of how more typical access control solutions can integrate with mobile devices 68, allowing the two solutions of the conventional system and the embodiment described with respect to FIG. 4 to co-exist, and provide a migration path from the conventional to current the invention.

In this embodiment, a user has an NFC capable mobile device 68, but the site still has the typical access controller 16 and a RFID reader 12c installed at the door 26 or 10, such as shown in FIG. 1. The user can be enrolled in the system via an operator at a client workstation 70. The system 62 stores all information about the user, permissions, and device in the access server 72. The operator also configures a virtual credential or card 12c for the user. The virtual credentials are securely pushed over the 3G/4G/WiFi network 66 to the user's mobile device 68. The user may now use the mobile device 68 as a card emulator to present at the RFID reader at the door.

The mobile device would act as a card like that described above with respect to FIG. 1.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

It is recognized that the authorizing device 28 could be other devices such as dedicated units associated with a particular facility 20. A user upon entering the facility 20 could be provided with the authorizing device 28 which is preloaded with facility information. The user could install a card, such as a SIM (subscriber identification module) containing the user's information. The user would still be required to identify the portal 26 such as by scanning an identifying mark 34 and providing authenticating information prior to the device 28 sending a signal 36 to the door striker 38.

While the identifying mark 38 is identified as a physical mark, it is recognized that the mark could be a wireless signal that is sent from the striker 38. In alternative, the striker 38 has a RFID.

What is claimed is:

1. A method for electronic access control to one or more secured portals comprising:
providing an authorizing device having information related to a particular facility and an user's access rights;
identifying with the authorizing device one of the secured portals to access;
receiving authentication by the authorizing device from the user to access the selected portal;
determining if access is to be granted based on the information related to the facility and the user including the selected portal and the authentication information; and
sending a signal to a secured portal if access is determined to be granted.

2. A method of claim 1 wherein the authorizing device receives the information related to the particular facility and the user's access rights wirelessly from a control center.

3. A method of claim 2 wherein the control center is remote from the particular facility.

4. A method of claim 1 wherein the authorizing device is a cellular telephone.

5. A method of claim 1 wherein the authorizing device is a dedicated device that contains the information related to the particular facility and information related to the user's access rights is installed with a card.

6. A method of claim 1 wherein the particular facility for which to download related information is determined by the authorizing device providing the authorizing device's location using cellular tower triangulation.

7. A method of claim 1 wherein the particular facility for which to download related information is determined by the authorizing device providing the authorizing device's location using the global positioning satellite system.

8. A system for electronic access control to one or more secured portals comprising:
an authorizing device capable of storing information related to a particular facility and a user's access rights, a mechanism for identifying a secured portal, a mechanism for authenticating a user, and a means for transmitting a signal wirelessly; and
at least one portal having a locking device capable for receiving a wireless signal from the authorizing device for granting access through the portal.

9. A system of claim 8 further comprises a control center and a wireless transmission mechanism for transmitting the information related to the particular facility and the user's access rights.

10. A system of claim 9 wherein the authorizing device's location and the particular facility to download is determined by the authorizing device's location using cellular tower triangulation.

11. A system of claim 8 wherein the authorizing device's location and the particular facility to download is determined by the authorizing device providing the authorizing device's location using the global positioning satellite system.

12. A system of claim 8 wherein the user's access rights are retained by a card held by the authorizing device.

13. A system of claim 8 wherein the authorizing device is a cellular telephone.

14. An authorizing device comprising:
a mechanism for storing information related to a particular facility and a user's access rights;
a mechanism for identifying a secured portal;
a mechanism for authenticating a user; and
a means for transmitting a signal wirelessly.

15. An authorizing device of claim 14 further comprising a wireless receiver for receiving the information related to the particular facility and the user's access rights based on the location of the authorizing device.

16. An authorizing device of claim 15 wherein the authorizing device's location is determined using cellular tower triangulation.

17. An authorizing device of claim 15 wherein the authorizing device's location is determined using the global positioning satellite system.

18. An authorizing device of claim 14 wherein the user's access rights are retained by a card held by the authorizing device.

19. An authorizing device of claim 14 wherein the authorizing device is a cellular telephone.
